(19) United States
(12) Patent Application Publication
(10) Pub. No.: US 2013/0181132 A1
(43) Pub. Date: Jul. 18, 2013

(54) INTRUSION DETECTION APPARATUS AND METHOD

(71) Applicant: Seung-Ki HONG, Daejeon (KR)

(72) Inventor: Seung-Ki HONG, Daejeon (KR)

(73) Assignee: Electronics and Telecommunications Research Institute, Daejeon (KR)

(21) Appl. No.: 13/612,705

(22) Filed: Sep. 12, 2012

(30) Foreign Application Priority Data
Jan. 16, 2012 (KR) 10-2012-0004820

(51) Int. Cl. G01J 5/08; G01C 3/08

(52) U.S. Cl. 250/338.2; 250/348; 250/206.1

(57) ABSTRACT

Disclosed herein is an intrusion detection apparatus which includes an infrared emission unit for emitting infrared beams and an infrared reception unit for receiving the infrared beams. The infrared emission unit adjusts an emission direction in which the infrared beams are emitted based on information received from the infrared reception unit, and adjusts an optical axis which is formed with the infrared reception unit depending on whether infrared beam values corresponding to the adjusted emission direction fall within the normal range. The infrared reception unit adjusts a detection direction in which the infrared beams are detected based on information received from the infrared emission unit, and adjusts an optical axis which is formed with the infrared emission unit depending on whether infrared beam values corresponding to the adjusted detection direction fall within the normal range. The intrusion into a relevant region is detected using the optical axis.

### CROSS REFERENCE TO RELATED APPLICATION

This application claims the benefit of Korean Patent Application No. 10-2012-0004820, filed on Jan. 16, 2012, which is hereby incorporated by reference in its entirety into this application.

### BACKGROUND OF THE INVENTION

1. Technical Field

The present invention relates generally to an intrusion detection apparatus and method. More particularly, the present invention relates to an intrusion detection apparatus and method which detect the intrusion of a person or an object into a relevant region using an infrared or laser source-based sensor in a movable form instead of a fixed form.

2. Description of the Related Art

Infrared detection apparatuses have been used to detect the intrusions of persons or objects into relevant regions. Such an infrared detection apparatus includes an infrared emission unit configured to emit infrared beams, and an infrared reception unit installed to face the infrared emission unit and configured to receive the emitted infrared beams.

When infrared beams between the infrared emission unit and the infrared reception unit are blocked by a person or an object, the infrared detection apparatus generates an intrusion signal. Accordingly, when an infrared detection apparatus is installed, an optical axis should be set such that the infrared emission unit and the infrared reception unit face each other.

As described above, whenever an infrared detection apparatus is manufactured or installed in a movable form instead of a fixed form, there is a problem in that an optical axis should be set such that an infrared emission unit and an infrared reception unit face each other. Furthermore, when an infrared detection apparatus is installed, there is a problem in that initial expenses are required to construct wiring for providing regular power and construct a communication environment or in that time is taken.

### SUMMARY OF THE INVENTION

Accordingly, the present invention has been made keeping in mind the above problems occurring in the prior art, and an object of the present invention is to provide an intrusion detection apparatus and method which detect the intrusion of a person or an object into a relevant region using an infrared or laser source-based sensor in a movable form instead of a fixed form.

In order to accomplish the above object, the present invention provides an intrusion detection apparatus including an infrared emission unit for emitting infrared beams; and an infrared reception unit for receiving the infrared beams emitted from the infrared emission unit. The infrared emission unit adjusts an emission direction in which the infrared beams are emitted based on information received from the infrared reception unit, and adjusts an optical axis which is formed with the infrared reception unit depending on whether infrared beam values corresponding to the adjusted emission direction fall within a normal range. The infrared reception unit adjusts a detection direction in which the infrared beams are detected based on information received from the infrared emission unit, and adjusts the optical axis which is formed with the infrared emission unit depending on whether infrared beam values corresponding to the adjusted detection direction fall within a normal range. The intrusion of a person or an object into a relevant region is detected using the optical axis between the infrared emission unit and the infrared reception unit.

The infrared emission unit may include an earth magnetic field sensor.

The infrared emission unit may obtain the emission direction in which the infrared beams are emitted based on the results of sensing performed by the earth magnetic field sensor.

The infrared reception unit may include an earth magnetic field sensor.

The infrared reception unit may obtain the detection direction in which the infrared beams are detected based on the results of sensing performed by the earth magnetic field sensor.

In order to accomplish the above object, the present invention provides an intrusion detection method using an apparatus including an infrared emission unit for emitting infrared beams and an infrared reception unit for receiving the infrared beams emitted from the infrared emission unit. The method includes, by the infrared emission unit, emitting the infrared beams; adjusting an emission direction in which the infrared beams are emitted based on information received from the infrared reception unit; determining whether infrared beam values corresponding to the adjusted emission direction fall within a normal range; if the infrared beam values fall within the normal range, setting an optical axis which is formed with the infrared reception unit based on the adjusted emission direction; and detecting the intrusion of a person or an object into a relevant region using the optical axis.

The intrusion detection method may further include obtaining the emission direction in which the infrared beams are emitted based on the results of sensing performed by a biaxial or triaxial earth magnetic field sensor.

The adjusting the emission direction may include adjusting the emission direction again when an infrared beam detection event signal is received from the infrared reception unit.

In order to accomplish the above object, the present invention provides an intrusion detection method using an apparatus including an infrared emission unit for emitting infrared beams and an infrared reception unit for receiving the infrared beams emitted from the infrared emission unit. The method includes, by the infrared reception unit, obtaining an infrared beam detection direction; adjusting the infrared beam detection direction based on information received from the infrared emission unit; determining whether infrared beam values corresponding to the adjusted detection direction fall within a normal range; setting an optical axis which is formed with the infrared emission unit based on the adjusted detection direction when the infrared beam values fall within the normal range; and detecting the intrusion of a person or an object into a relevant region using the optical axis.

The obtaining the infrared beam detection direction may include obtaining the infrared beam detection direction based on the results of sensing performed by a biaxial or triaxial earth magnetic field sensor.

The adjusting the infrared beam detection direction may include generating an infrared beam detection event signal if each of the infrared beam values corresponding to the adjusted detection direction is equal to or greater than a specific value; and adjusting the detection direction again after the infrared beam detection event signal has been generated.

In order to accomplish the above object, the present invention provides an intrusion detection apparatus including a sensor module configured such that an emission unit for emitting beams and a reception unit for receiving the beams emitted from the emission unit are integrated into a single structure; a displacement measurement unit configured to measure the displacement of a distance value measured by the sensor module; and an intrusion determination unit configured to determine whether an intrusion into a relevant region occurs based on whether the displacement of the distance value is generated.

The sensor module may correspond to a diffused reflection photo sensor or a distance measurement photo sensor.

The intrusion determination unit may determine that an intrusion into the relevant region occurs when the displacement of the distance value is generated.

The intrusion detection apparatus may further include a wireless communication unit for providing the results of the determination performed by the intrusion determination unit to a user via wireless communication.

In order to accomplish the above object, the present invention provides an intrusion detection method including measuring a distance value at each set time interval using a sensor module in which an emission unit for emitting beams and a reception unit for receiving the beams emitted from the emission unit are integrated into a single structure; measuring the displacement of the distance value; and determining whether an intrusion into a relevant region occurs based on the results of the measuring of the displacement of the distance value.

The determining may include determining that the intrusion into the relevant region occurs when the displacement of the distance value is generated.

The sensor module may correspond to a diffused reflection photo sensor or a distance measurement photo sensor.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view schematically illustrating the configuration of an intrusion detection apparatus according to a first embodiment of the present invention;

FIG. 2 is a view illustrating the configuration of an infrared emission unit according to the first embodiment of the present invention;

FIG. 3 is a view illustrating the configuration of an infrared reception unit according to the first embodiment of the present invention;

FIG. 4 is a flowchart illustrating an intrusion detection method according to the first embodiment of the present invention;

FIG. 5 is a view schematically illustrating the configuration of an intrusion detection apparatus according to a second embodiment of the present invention;

FIG. 6 is a flowchart illustrating an intrusion detection method according to the second embodiment of the present invention; and

FIG. 7 is a view schematically illustrating the configuration of the infrared emission unit and the infrared reception unit according to the first embodiment of the present invention.

### DESCRIPTION OF THE PREFERRED EMBODIMENTS

The present invention will be described in detail with reference to the accompanying drawings below. Here, when descriptions are repetitive and detailed descriptions of well-known functions or configurations would unnecessarily obscure the gist of the present invention, they will be omitted. The embodiments of the present invention are provided to complete the description for those skilled in the art of the present invention. Therefore, the shapes and sizes of components in the drawings may be exaggerated to provide more precise descriptions.

An intrusion detection apparatus and method according to embodiments of the present invention will be described in detail below with reference to the accompanying drawings.

First, in order to overcome the problem of a conventional manual installation process, the intrusion detection apparatus according to the embodiment of the present invention can detect the intrusion of a person or an object into a relevant region by automatically setting a location during a process of detecting the intrusion in the corresponding region.

FIG. 1 is a view schematically illustrating the configuration of an intrusion detection apparatus according to a first embodiment of the present invention.

Referring to FIG. 1, the intrusion detection apparatus includes an infrared emission unit 100 for emitting infrared beams and an infrared reception unit 200 for receiving the infrared beams emitted from the infrared emission unit 100. Here, the type of infrared beams may be laser beams, but is not limited thereto.

The distance between the infrared emission unit 100 and the infrared reception unit 200 may be in a range from at least tens of centimeters (cm) to a maximum of tens of meters (m), but is not limited thereto.

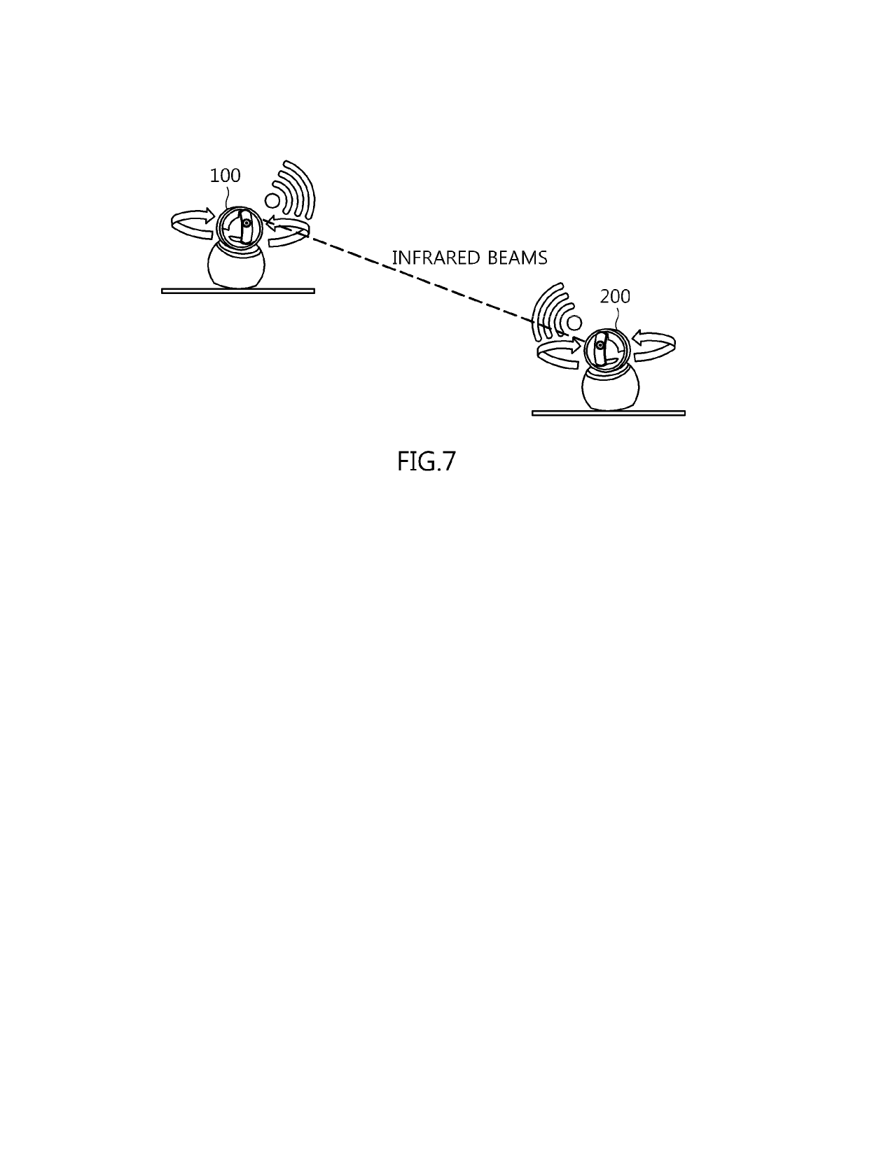

In the intrusion detection apparatus according to the embodiment of the present invention, the infrared emission unit 100 and the infrared reception unit 200 mutually share information via wireless communication as shown in FIG. 7, and adjust an optical axis based on the information being shared, thereby detecting the intrusion of a person or an object into a relevant region using the adjusted optical axis.

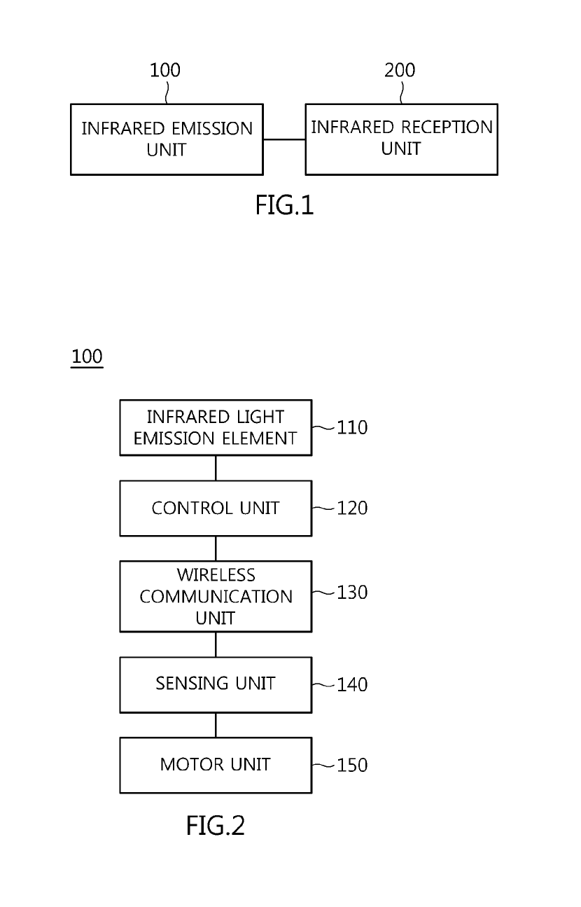

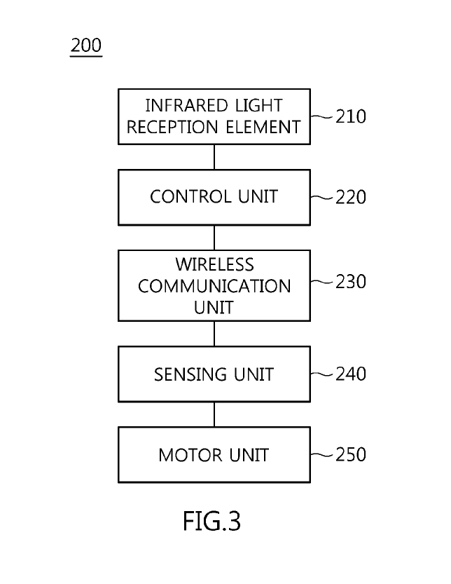

Next, the configurations of the infrared emission unit 100 and the infrared reception unit 200 will be described in detail with reference to FIGS. 2 and 3.

FIG. 2 is a view illustrating the configuration of the infrared emission unit 100 according to the first embodiment of the present invention. FIG. 3 is a view illustrating the configuration of the infrared reception unit 200 according to the first embodiment of the present invention.

Referring to FIG. 2, the infrared emission unit 100 includes at least one of an infrared light emission element 110, a control unit 120, a wireless communication unit 130, a sensing unit 140 and a motor unit 150.

Referring to FIG. 3, the infrared reception unit 200 includes at least one infrared light reception element 210, a control unit 220, a wireless communication unit 230, a sensing unit 240, and a motor unit 250.

Referring to FIGS. 2 and 3, the intrusion detection apparatus can detect the intrusion of a person or an object into a relevant region using batteries (not shown) which are provided in the respective infrared emission unit 100 and infrared reception unit 200, respectively. That is, a low-power operation and communication technique can be applied to the intrusion detection apparatus according to the embodiment of the present invention.

Further, at least one infrared light emission element 110 and at least one infrared light reception element 210 face each other and form an optical axis. The optical axis corresponds to a boundary line which is used by the intrusion detection apparatus in order to detect the intrusion of a person or an object into a relevant region.

Referring to FIG. 2, at least one infrared light emission element 110 corresponds to an Infrared Light Emitting Diode (IR LED).

The control unit 120 obtains an infrared beam emission direction at a current time point based on the results of sensing performed by the sensing unit 140, that is, the direction of the earth's magnetic field.

The wireless communication unit 130 wirelessly communicates with the infrared reception unit 200. In detail, the wireless communication unit 130 transmits information about the infrared beam emission direction obtained by the control unit 120 to the infrared reception unit 200, and receives information about the light reception of the infrared reception unit 200, for example, the infrared beam detection direction, from the infrared reception unit 200.

The control unit 120 adjusts the location of the infrared emission unit 100, that is, the direction in which the infrared light emission element 110 emits infrared beams (hereinafter referred to as the “the emission direction”) in the direction which is different from the infrared beam detection direction by 180 degrees, based on the information shared using the wireless communication unit 130, that is, the infrared beam detection direction. As described above, in an emission direction adjustment process, the infrared emission unit 100 successively emits infrared beams.

Next, after the emission direction of the infrared light emission element 110 has been adjusted using the motor unit 150 such that the emission direction corresponds to a received infrared beam detection event signal, the control unit 120 determines whether infrared beam values corresponding to the adjusted emission direction fall within a normal range.

When the infrared beam values corresponding to the infrared beam emission direction fall within the normal range, the control unit 120 determines that the optical axis formed with the infrared reception unit 200 has been precisely set, and completes an optical axis setting process.

When the infrared beam values corresponding to the infrared beam emission direction do not fall within the normal range, the control unit 120 performs control such that the motor unit 150 adjusts the location of the infrared light emission element 110 again, and then completes the optical axis setting process.

The sensing unit 140 corresponds to a biaxial (x axis and y axis) or triaxial (x axis, y axis, and z axis) earth magnetic field sensor. Here, the earth magnetic field sensor is a sensor which functions as a compass, and obtains the values of the strength and direction of the earth's magnetic field within an error range set by the infrared emission unit 100 in advance.

The motor unit 150 performs and controls the panning and tilting of the infrared emission unit 100.

When the motor unit 150 receives the infrared beam detection event signal from the infrared reception unit 200 via the wireless communication unit 130, the motor unit 150 adjusts the emission direction of the infrared light emission element 110 while taking into consideration driving inertia and a delayed event processing time. Here, the driving inertia is information about minute inertia which is generated during a process in which the infrared light emission element 110 emits infrared beams, and the delayed event processing time is a delayed time which is generated during an event processing process and corresponds to the infrared beam detection event signal.

Referring to FIG. 3, at least one infrared light reception element 210 corresponds to a photodiode or a phototransistor.

The control unit 220 obtains an infrared beam detection direction at a current time point based on the results of sensing performed by the sensing unit 240, that is, the direction of the earth's magnetic field.

The wireless communication unit 230 wirelessly communicates with the infrared emission unit 100. In detail, the wireless communication unit 230 transmits information about the infrared beam detection direction obtained by the control unit 220 to the infrared emission unit 100, and receives the light emission information of the infrared emission unit 100, for example, the infrared beam emission direction, from the infrared emission unit 100.

The control unit 220 adjusts the location of the infrared reception unit 200, that is, the direction in which the infrared light reception element 210 detects infrared beams (hereinafter referred to as the “infrared beam detection direction”) in the direction which is different from the infrared beam emission direction by 180 degrees, based on the information shared using the wireless communication unit 230, that is, the infrared beam emission direction. As described above, in a detection direction adjustment process, the infrared reception unit 200 continuously detects the infrared beam detection direction.

Next, when the infrared beam values, which correspond to the infrared beam detection direction and each of which is equal to or greater than a predetermined value, is detected, the control unit 220 generates an infrared beam detection event signal. Here, the control unit 220 generates the infrared beam detection event signal while stopping at least one operation of the infrared light reception element 210, and transmits the infrared detection event signal to the infrared emission unit 100 via the wireless communication unit 230.

After the detection direction of the infrared light reception element 210 has been adjusted using the motor unit 250 such that the detection direction corresponds to the infrared beam detection event signal, the control unit 220 determines whether infrared beam values corresponding to the infrared beam detection direction fall within the normal range.

When the infrared beam values corresponding to the infrared beam detection direction fall within the normal range, the control unit 220 determines that the optical axis formed with the infrared emission unit 100 has been precisely set, and completes an optical axis setting process.

When the infrared beam values corresponding to the infrared beam detection direction do not fall within the normal range, the control unit 220 performs control such that the motor unit 250 adjusts the location of the infrared light reception element 210 again, thereby completing the optical axis setting process.

The control unit 220 completes the optical axis setting process, and detects the intrusion of a person or an object using the set optical axis.

The sensing unit 240 corresponds to a biaxial (x axis and y axis) or triaxial (x axis, y axis, and z axis) earth magnetic field sensor. Here, the earth magnetic field sensor is a sensor which functions as a compass, and obtains the values of the strength and direction of the earth's magnetic field within an error range set by the infrared reception unit 200 in advance.

The earth magnetic field sensors in the infrared emission unit 100 and the infrared reception unit 200 according to the first embodiment of the present invention obtain the same value.

The motor unit 250 performs and controls the panning and tilting of the infrared reception unit 200.

The motor unit 250 adjusts the detection direction of the infrared light reception element 210 while taking into consideration the driving inertia and the delayed event processing time from a point of time at which the infrared beam detection event signal was generated by the control unit 220. Here, the driving inertia is information about minute inertia which is generated during a process in which the infrared light reception element 210 detects the infrared beam, and the delayed event processing time is a delayed time which is generated during an event processing process and corresponds to the infrared beam detection event signal.

As described above, the motor unit 250 minutely adjusts the location of the infrared light reception element 210 from the time at which the infrared beam detection event signal was generated, thereby enabling the infrared light reception element 210 to accurately detect infrared beams.

According to the embodiment of the present invention, the motor unit 150 of the infrared emission unit 100 and the motor unit 250 of the infrared reception unit 200 maintain the same driving angular velocity in the same direction at the same time, that is, in a clockwise or counterclockwise direction, when the infrared emission unit 100 and the infrared reception unit 200 are oriented at respective angles which are different from each other by 180 degrees. Further, the motor unit 150 of the infrared emission unit 100 and the motor unit 250 of the infrared reception unit 200 are driven until the time before the infrared beam detection event signal is generated by the control unit 220. The above-described process of driving the motor units 150 and 250 should be completed before the emission direction and detection direction respectively corresponding to the infrared emission unit 100 and the infrared reception unit 200 have rotated up to 360 degrees.

According to the first embodiment of the present invention, when the optical axis setting processes performed by the infrared emission unit 100 and the infrared reception unit 200 has completed, the infrared emission unit 100 and the infrared reception unit 200 face each other. Therefore, when the infrared emission unit 100 emits infrared beams, the infrared reception unit 200 can detect the infrared beams, so that a boundary line is formed using the infrared beam.

For example, when the optical axis setting process is completed, the infrared reception unit 200 continuously detects infrared beams emitted by the infrared emission unit 100. If, as the results of the detection, a change in the strength of infrared beams occurs, it is regarded as an intrusion situation, and the infrared reception unit 200 generates an intrusion event. Here, the intrusion situation is a situation in which the intrusion of a person or an object into a relevant region is detected. Further, the infrared reception unit 200 transmits a warning message corresponding to the intrusion event to a user via wireless communication. Here, the type of the warning message may be voice or vibration, but is not limited thereto.

According to the first embodiment of the present invention, the infrared reception unit 200 may be of a mirror reflection type. Here, the infrared reception unit 200 reflects the infrared beams emitted from the infrared emission unit 100, so that the infrared emission unit 100 can detect the reflected infrared beams.

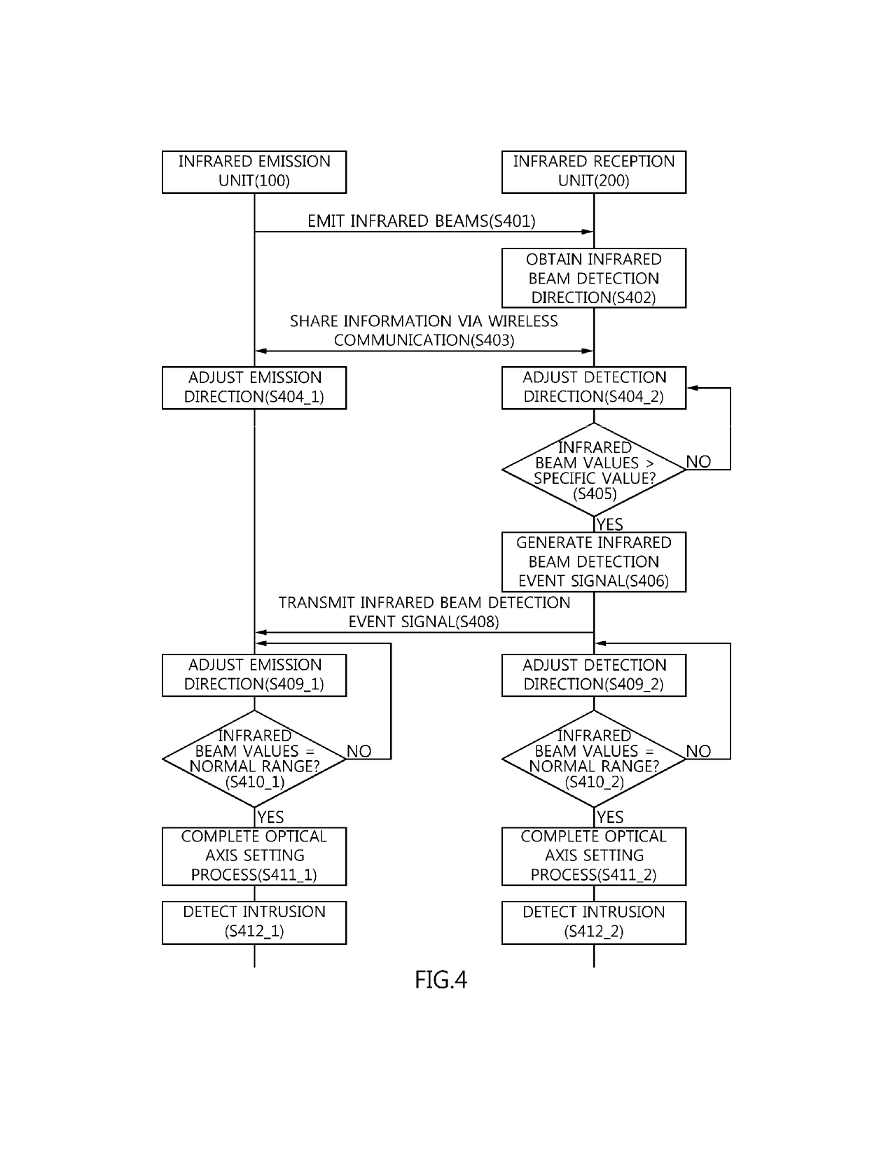

Next, an intrusion detection method according to the first embodiment of the present invention will be described in detail with reference to FIG. 4.

FIG. 4 is a flowchart illustrating the intrusion detection method according to the first embodiment of the present invention.

First, the intrusion detection apparatus according to the first embodiment of the present invention includes the infrared emission unit 100 and the infrared reception unit 200.

Referring to FIG. 4, the infrared emission unit 100 emits infrared beams using the infrared light emission element 110 at step S401. Here, the infrared light emission element 110 corresponds to an infrared light emitting diode.

Thereafter, the infrared reception unit 200 receives the infrared beams using the infrared light reception element 210, and obtains an infrared beam detection direction based on the received infrared beams at step S402.

The infrared emission unit 100 and the infrared reception unit 200 share beam emission information and beam reception information, such as the infrared beam emission direction and the infrared beam detection direction, via wireless communication at step S403.

The infrared emission unit 100 adjusts a direction in which the infrared light emission element 110 emits infrared beams in a direction (hereinafter referred to as the “emission direction”) which is different from the infrared beam detection direction by 180 degrees based on the information shared at step S403, that is, the infrared beam emission direction and the infrared beam detection direction at step S404_1.

The infrared reception unit 200 adjusts the location of the infrared reception unit 200, that is, the direction in which the infrared light reception element 210 detects the location of the infrared reception unit 200 (hereinafter referred to as the “detection direction”) in a direction which is different from the infrared beam emission direction by 180 degrees based on the information shared at step S403, that is, the infrared beam emission direction and the infrared beam detection direction at step S404_2.

Thereafter, the infrared reception unit 200 determines whether each of infrared beam values corresponding to the infrared beam detection direction is equal to or greater than a predetermined value. When infrared beam values each of which is equal to or greater than the predetermined value are not detected, the infrared reception unit 200 adjusts the detection direction as at step S404_2. In contrast, when infrared beam values each of which is equal to or greater than the predetermined value is detected, the infrared reception unit 200 generates an infrared beam detection event signal at step S406.

The infrared reception unit 200 transmits the infrared detection event signal to the infrared emission unit 100 at step S408.

After step S408 has been performed, the infrared emission unit 100 adjusts the emission direction of the infrared light emission element 110 such that the emission direction corresponds to the received infrared beam detection event signal at step S409_1, and determines whether the infrared beam values corresponding to the adjusted emission direction fall within the normal range at step S410_1.

If the infrared beam values corresponding to the adjusted emission direction fall within the normal range, the infrared emission unit 100 determines that the optical axis formed by the infrared reception unit 200 has been accurately set, and completes the optical axis setting process at step S411_1.

Thereafter, the infrared emission unit 100 completes the optical axis setting process, and detects the intrusion of a person or an object using the set optical axis at step S412_1.

Repeatedly, after step S408 has been performed, the infrared reception unit 200 adjusts the detection direction of the infrared light reception element 210 such that the detection direction corresponds to the generated infrared beam detection event signal at step S409_2, and determines whether the infrared beam values corresponding to the adjusted detection direction fall within the normal range at step S410_2.

If the infrared beam values corresponding to the adjusted detection direction fall within the normal range, the infrared reception unit 200 determines that the optical axis formed by the infrared emission unit 100 has been accurately set, and completes the optical axis setting process at step S411_2.

Thereafter, the infrared reception unit 200 completes the optical axis setting process, and detects the intrusion of a person or an object using the set optical axis at step S412_2.

Next, an intrusion detection apparatus according to a second embodiment of the present invention will be described in detail with reference to FIG. 5.

FIG. 5 is a diagram schematically illustrating the configuration of the intrusion detection apparatus according to the second embodiment of the present invention.

First, unlike in the intrusion detection apparatus according to the first embodiment, an emission unit and a reception unit are integrated into a single structure in the intrusion detection apparatus according to the second embodiment of the present invention.

Referring to FIG. 5, an intrusion detection apparatus 500 includes a sensor module 510, a displacement measurement unit 520, an intrusion determination unit 530, and a wireless communication unit 540.

The sensor module 510 is a module in which an emission unit 511 and a reception unit 512 are integrated into a single structure. The sensor module 510 corresponds to a diffused reflection photo sensor or a distance measurement photo sensor, but is not limited thereto.

The diffused reflection photo sensor is a sensor which emits beams and directly receives beams directly reflected on a light reception element, thereby monitoring the presence of an object which makes intrusions into a relevant boundary in real time within a near field. Here, the beams may be infrared beams, laser beams or ultrasonic waves, but are not limited thereto.

The distance measurement photo sensor is a sensor which can measure a distance using infrared or laser beams, and can monitor the presence of an object which makes intrusions into a relevant boundary in real time based on the displacement of the measured distance.

It is assumed that the sensor module 510, for example, a distance measurement photo sensor, is installed at a desired location for detection.

The emission unit 511 of the distance measurement photo sensor emits infrared beams, and the reception unit 512 of the distance measurement photo sensor receives reflected beams. By means of this process, the distance measurement photo sensor measures a distance at each set time interval. Here, an initially measured distance corresponds to a reference measurement value.

The displacement measurement unit 520 measures a change in the distance measured by the distance measurement photo sensor. For example, when an object or a person makes an intrusion into a boundary at a specific instant, a displacement of the distance occurs.

The intrusion determination unit 530 determines whether an intrusion has been made based on the results of the measurement performed by the displacement measurement unit 520. When the displacement of the distance occurs, the intrusion determination unit 530 determines that an intrusion has made into the corresponding boundary. When the displacement of the distance does not occur, the intrusion determination unit 530 determines that the situation is normal.

The wireless communication unit 540 can remotely provide the results of the determination of the intrusion determination unit 530 to a user via wireless communication.

Further, an intrusion detection method according to the second embodiment of the present invention enables the entrance of an object or a person into a specific region to be detected using two or more sensor modules 510, and the number of entrances to be counted for a given time range. Here, two or more sensor modules 510 are arranged to be separated by a predetermined distance and disposed in parallel.

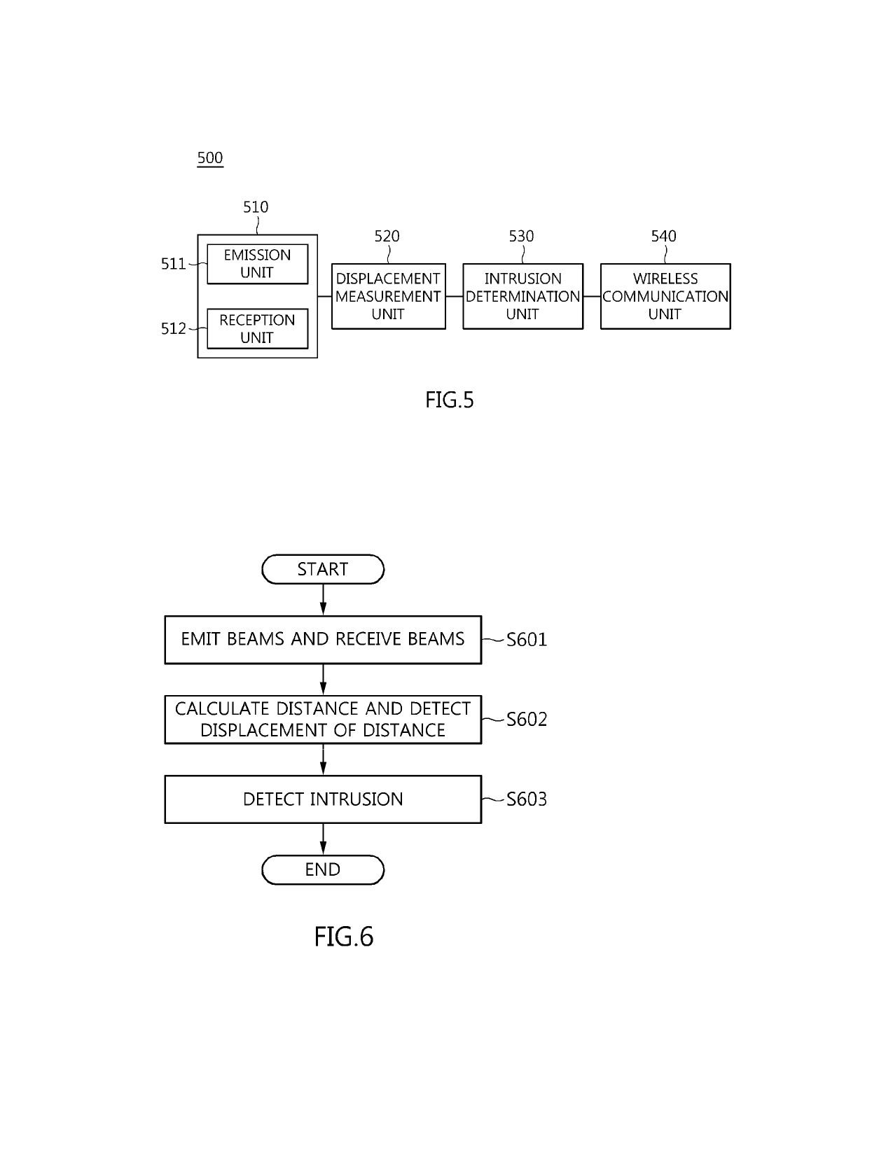

Next, the intrusion detection method according to the second embodiment of the present invention will be described in detail with reference to FIG. 6.

FIG. 6 is a flowchart illustrating the intrusion detection method according to the second embodiment of the present invention.

First, unlike in the intrusion detection apparatus according to the first embodiment, an emission unit and a reception unit are integrated into a single structure and are configured to detect an intrusion into a relevant region in the intrusion detection apparatus according to the second embodiment of the present invention.

Referring to FIG. 6, the intrusion detection apparatus emits infrared beams and receives reflected infrared beams using the distance measurement photo sensor at step S601. Here, the distance measurement photo sensor is a sensor which can measure a distance using infrared or laser beams, and can monitor the presence of an object which makes an intrusion into a relevant boundary based on the displacement of the measured distance in real time.

The intrusion detection apparatus measures the distance using the process performed at step S601, and detects whether the displacement of the measured distance occurs at step S602. Here, a distance which is initially measured corresponds to a reference measurement value. At step S602, the displacement of the distance occurs when an object or a person makes an intrusion into a boundary at a specific time.

When the displacement of the distance occurs, the intrusion detection apparatus determines that intrusion into the relevant boundary has been made at step S603. Meanwhile, when the displacement of the distance does not occur, the intrusion detection apparatus determines that the situation is normal.

The intrusion detection apparatus according to the first and second embodiments of the present invention may further include a human body detection sensor (not shown). Since an infrared or laser beam-based sensing unit requires comparatively high power when the sensing unit operates, the sensing unit requires high battery consumption, thereby affecting the lifespan of the battery. However, an intrusion detection sensor which includes a human body sensor performs control such that the infrared or laser-based sensing unit operates only when the human body detection sensor generates a human body detection signal, thereby reducing battery consumption.

According to the embodiments of the present invention, the intrusion detection apparatus automatically adjusts an optical axis between the infrared emission unit and the infrared reception unit, thereby detecting an intrusion into a relevant region from outside using the adjusted optical axis.

According to the embodiments of the present invention, the intrusion detection method automatically adjusts an optical axis between the infrared emission unit and the infrared reception unit, thereby being easily applied to the field of intrusion detection apparatuses which are temporarily installed.

In addition, according to the embodiments of the present invention, the intrusion detection apparatus can allow the infrared emission unit and the infrared reception unit to be integrated into a single structure using a diffused reflection photo sensor, a laser, or an infrared distance measurement sensor, and can detect intrusions into two or more boundaries using two or more sensors. Further, according to the embodiments of the present invention, the intrusion detection apparatus can detect the entrance at a specific location or boundary using two or more sensors, and can count the number of entrances.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An intrusion detection apparatus comprising:
an infrared emission unit for emitting infrared beams; and
an infrared reception unit for receiving the infrared beams emitted from the infrared emission unit;
wherein the infrared emission unit adjusts an emission direction in which the infrared beams are emitted based on information received from the infrared reception unit, and adjusts an optical axis which is formed with the infrared reception unit depending on whether infrared beam values corresponding to the adjusted emission direction fall within a normal range;
wherein the infrared reception unit adjusts a detection direction in which the infrared beams are detected based on information received from the infrared emission unit, and adjusts the optical axis which is formed with the infrared emission unit depending on whether infrared beam values corresponding to the adjusted detection direction fall within a normal range; and
wherein an intrusion of a person or an object into a relevant region is detected using the optical axis between the infrared emission unit and the infrared reception unit.

2. The intrusion detection apparatus as set forth in claim 1, wherein the infrared emission unit comprises an earth magnetic field sensor.

3. The intrusion detection apparatus as set forth in claim 2, wherein the infrared emission unit obtains the emission direction in which the infrared beams are emitted based on results of sensing performed by the earth magnetic field sensor.

4. The intrusion detection apparatus as set forth in claim 1, wherein the infrared reception unit comprises an earth magnetic field sensor.

5. The intrusion detection apparatus as set forth in claim 4, wherein the infrared reception unit obtains the detection direction in which the infrared beams are detected based on results of sensing performed by the earth magnetic field sensor.

6. An intrusion detection method using an apparatus including an infrared emission unit for emitting infrared beams and an infrared reception unit for receiving the infrared beams emitted from the infrared emission unit, the intrusion detection method comprising:
by the infrared emission unit,
emitting the infrared beams;
adjusting an emission direction in which the infrared beams are emitted based on information received from the infrared reception unit;
determining whether infrared beam values corresponding to the adjusted emission direction fall within a normal range;
when the infrared beam values fall within the normal range, setting an optical axis which is formed with the infrared reception unit based on the adjusted emission direction; and
detecting an intrusion of a person or an object into a relevant region using the optical axis.

7. The intrusion detection method as set forth in claim 6, further comprising obtaining the emission direction in which the infrared beams are emitted based on results of sensing performed by a biaxial or triaxial earth magnetic field sensor.

8. The intrusion detection method as set forth in claim 6, wherein the adjusting the emission direction comprises adjusting the emission direction again when an infrared beam detection event signal is received from the infrared reception unit.

9. An intrusion detection method using apparatus including an infrared emission unit for emitting infrared beams, and an infrared reception unit for receiving the infrared beams emitted from the infrared emission unit, the intrusion detection method comprising:
by the infrared reception unit,
obtaining an infrared beam detection direction;
adjusting the infrared beam detection direction based on information received from the infrared emission unit;
determining whether infrared beam values corresponding to the adjusted detection direction fall within a normal range;
if the infrared beam values fall within the normal range, setting an optical axis which is formed with the infrared emission unit based on the adjusted detection direction; and
detecting an intrusion of a person or an object into a relevant region using the optical axis.

10. The intrusion detection method as set forth in claim 9, wherein the obtaining the infrared beam detection direction comprises obtaining the infrared beam detection direction based on results of sensing performed by a biaxial or triaxial earth magnetic field sensor.

11. The intrusion detection method as set forth in claim 9, wherein the adjusting the infrared beam detection direction comprises:
generating an infrared beam detection event signal if each of the infrared beam value corresponding to the adjusted detection direction is equal to or greater than a specific value; and
adjusting the detection direction again after the infrared beam detection event signal has been generated.

12. An intrusion detection apparatus comprising:
a sensor module configured such that an emission unit for emitting beams and a reception unit for receiving the beams emitted from the emission unit are integrated into a single structure;
a displacement measurement unit configured to measure a displacement of a distance value detected the sensor module; and
an intrusion determination unit configured to determine whether an intrusion into a relevant region occurs based on whether the displacement of the distance value is generated.

13. The intrusion detection apparatus as set forth in claim 12, wherein the sensor module corresponds to a diffused reflection photo sensor or a distance measurement photo sensor.

14. The intrusion detection apparatus as set forth in claim 12, wherein the intrusion determination unit determines that an intrusion into the relevant region occurs when the displacement of the distance value is generated.

15. The intrusion detection apparatus as set forth in claim 12, further comprising a wireless communication unit for providing results of the determination performed by the intrusion determination unit to a user via wireless communication.

16. An intrusion detection method comprising:
measuring a distance value at each set time interval using a sensor module in which an emission unit for emitting beams and a reception unit for receiving the beams emitted from the emission unit are integrated into a single structure;
measuring a displacement of the distance value; and
determining whether an intrusion into a relevant region occurs based on results of the measuring of the displacement of the distance value.

17. The intrusion detection method as set forth in claim 16, wherein the determining comprises determining that the intrusion into the relevant region occurs when the displacement of the distance value is generated.

18. The intrusion detection method as set forth in claim 16, wherein the sensor module corresponds to a diffused reflection photo sensor or a distance measurement photo sensor.
